(19) United States
(12) Patent Application Publication
(10) Pub. No.: US 2003/0103162 A1
(43) Pub. Date: Jun. 5, 2003

(54) Image display system

(75) Inventors: Hiroyasu Sano, Tokyo (JP); Toru Hidaka, Tokyo (JP); Akihiro Kubota, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Olympus Optical Co. Ltd., Tokyo (JP)

(21) Appl. No.: 10/309,517

(22) Filed: Dec. 4, 2002

(30) Foreign Application Priority Data
Dec. 5, 2001 (JP) 2001-371787

(51) Int. Cl. H04N 5/66; H04N 9/12

(52) U.S. Cl. 348/383; 348/744

(57) ABSTRACT

Disclosed is an image display system which provides a display by joining projected images together, comprising a plurality of projecting means for projecting images, display means for displaying a single image by joining the images from the projecting means together, dividing means for dividing the images projected by the projecting means into a plurality of processing unit areas, and correction processing means for performing correction processing for each of the processing unit areas, wherein the processing unit areas differ in size between joint portions of the images projected by the projecting means and other portions than the joint portions.

### CROSS-REFERENCE TO RELATED APPLICATIONS

This application is based upon and claims the benefit of priority from the prior Japanese Patent Application No. 2001-371787, filed Dec. 5, 2001, the entire contents of which are incorporated herein by reference.

### BACKGROUND OF THE INVENTION

1. Field of the Invention

The present invention relates to an image display system which displays a single image with images from two or more image projectors. More specifically, the present invention relates to an image display system which joins projected images together to display an image.

2. Description of the Related Art

An image display system has been proposed which projects images onto a screen using two or more image projectors and joins the projected images together on the screen to thereby provide a large-screen display. With such an image display system, it is essential to display a seamless image in which joints of the projected images are inconspicuous.

A problem arises in that, in screen sections (joints) where projected images are joined together, images from projectors overlap with each other and such screen sections increase in brightness in comparison with other screen sections. To solve such a problem, Jpn. Pat. Appln. KOKAI Publication No. 5-103286 discloses a method to adjust the brightness of the joints through the use of a shading member. To compensate for the difference in processing time among projectors, Jpn. Pat. Appln. KOKAI Publication No. 2001-222269 discloses a method which shifts signals in the direction of time axis. There is a difference in characteristic among subareas of the display area of a projector, resulting in color nonuniformity. There has been proposed in Jpn. Pat. Appln. KOKAI Publication No. 7-50795 a method for suppressing color nonuniformity by dividing the display area into subareas and performing correction processing using a different input-output characteristic for each subarea.

With the method which uses a shading member to adjust the brightness, however, it is highly possible that, in portions where light is shaded by the shading member, the characteristic may abruptly vary between adjacent pixels; thus, color nonuniformity is liable to occur. For this reason, one may suggest dividing the area into subareas and performing correction processing for each subarea; however, subdivision of the entire area would involve an overwhelming amount of data.

### BRIEF SUMMARY OF THE INVENTION

It is an object of the present invention to allow an image display system adapted to display a single image by joining images from two or more projectors together on a screen to prevent image degradations such as brightness and color nonuniformity and to keep the amount of data used in correction processing from increasing.

According to an aspect of the present invention, there is provided an image display system which provides a display by joining projected images together, comprising: a plurality of projecting means for projecting images; display means for displaying a single image by joining the images from the projecting means together; dividing means for dividing the images projected by the projecting means into a plurality of processing unit areas; and correction processing means for performing correction processing for each of the processing unit areas; wherein the processing unit areas differ in size between joint portions of the images projected by the projecting means and other portions than the joint portions.

It is desirable that the size of the processing unit areas be smaller in the joint portions than in the other portions.

The correction processing means may perform correction processing on the basis of previously stored input-output characteristic data specific to each of the processing unit areas.

The correction processing means may have select means for selecting an item of input-output characteristic data suitable for each processing unit area from among a plurality of items of previously stored input-output characteristic data and performs correction processing based on the input-output characteristic data selected by the select means.

The correction processing means may perform interpolation operations based on the results of correction processing on at least two specific areas contained in the processing unit area, thereby performing correction processing on a plurality of processing blocks contained in the processing unit area.

The processing unit area may be made up of (2^{m}+1)(2ⁿ+1) processing blocks with (2^{m}+1) rows and (2ⁿ+1) columns where m and n are positive integers, and the interpolation operation is performed using bit shift operations of digital values.

The image display system may further comprise storage means for previously storing input-output characteristic data for a specific processing block in a plurality of processing blocks contained in each processing unit area, and the correction processing means may seek input-output characteristic data for other processing blocks than the specific processing block by operations based on a position relationship between the specific processing block and the other processing blocks and the input-output characteristic data previously stored in the storage means and perform correction processing on the basis of the input-output characteristic data previously stored in the storage means and the input-output characteristic data sought by the operations.

The correction processing means may have a function of performing correction processing using input-output characteristic data specific to each of primary colors.

The image display system may further comprise: imaging means for capturing the state on a screen that forms the display means; determination means for determining the size of overlapped portions in the joint portions on the basis of an image obtained by the imaging means; and means for setting the size of each processing unit area on the basis of the results of determination by the determination means.

The image display system may further comprise: numerical value input means through which numerical values are externally input; and means for setting the size of each processing unit area on the basis of numerical values input through the numerical value input means.

Additional objects and advantages of the invention will be set forth in the description which follows, and in part will be obvious from the description, or may be learned by practice of the invention. The objects and advantages of the invention may be realized and obtained by means of instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a schematic illustration of an image display system according to a first embodiment of the present invention;

FIGS. 2A and 2B illustrate processing unit areas for images output from the projectors (imaging devices) in the image display system of FIG. 1;

FIG. 3 is a schematic block diagram of the image processing units shown in FIG. 1;

FIG. 4 is a schematic block diagram of image processing units according to a second embodiment of the present invention;

FIG. 5A is a schematic block diagram of image processing units according to a third embodiment of the present invention;

FIG. 5B illustrates pixel interpolation areas in accordance with the third embodiment;

FIG. 6A illustrates a relation among a processing unit area, pixel interpolation areas and pixels in accordance with the third embodiment;

FIG. 6B illustrates the input-output characteristics of pixels in accordance with the fifth embodiment;

FIG. 7A is a schematic block diagram of image processing units according to a fourth embodiment of the present invention;

FIG. 7B illustrates the configuration of the shift operations unit of FIG. 7A;

FIG. 7C illustrates a pixel interpolation area used in the fourth embodiment;

FIG. 8 is a schematic block diagram of image processing units according to a fifth embodiment of the present invention;

FIG. 9 is a schematic illustration of an image display system according to a sixth embodiment of the present invention; and

FIG. 10 is a schematic illustration of an image display system according to a seventh embodiment of the present invention.

### DETAILED DESCRIPTION OF THE INVENTION

The embodiments of the present invention will be described hereinafter with reference to the accompanying drawings.

First Embodiment

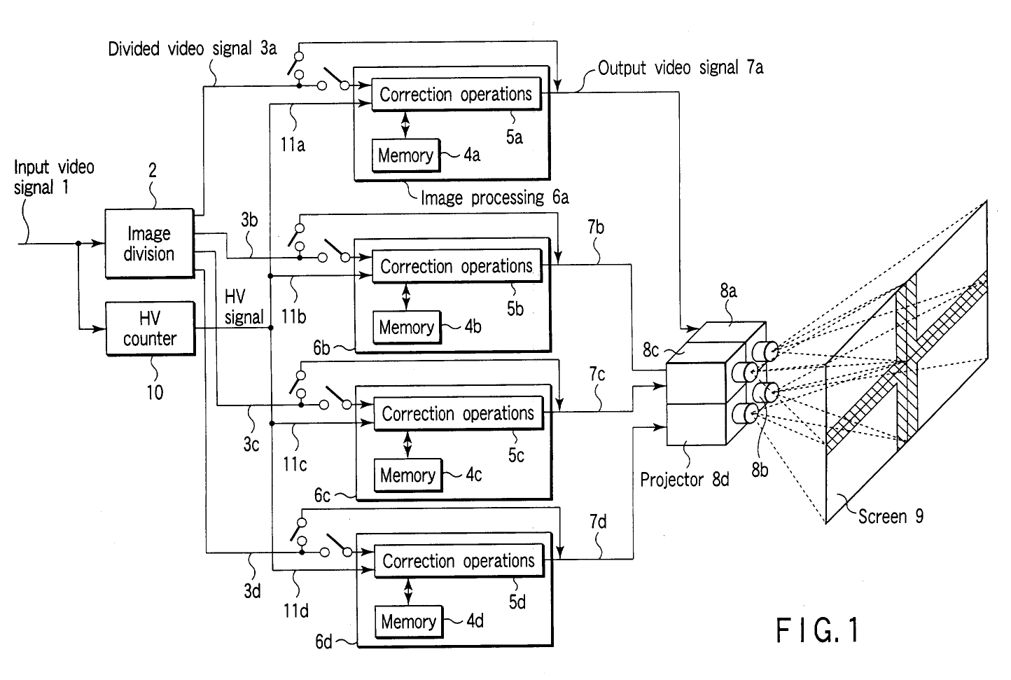

FIG. 1 is a schematic representation of an image display system according to a first embodiment of the present invention.

An input video signal 1 is entered into an image dividing unit 2, which provides divided video signals 3a to 3d each of which corresponds in position to a respective corresponding one of projectors 8a to 8d. The input video signal 1 is also entered into an HV counter 10, which outputs HV signals 11a to lid each of which represents the on-screen position of the input video signal 1.

The divided video signals 3a to 3d and the HV signals 11a to 11d are entered into image processing units 6a to 6d. Each of the image processing units 6a to 6d carries out predetermined correction processing on each of processing unit areas divided by predetermined dividing means. The image processing units 6a to 6d outputs corrected signals as output video signals 7a to 7d. By using switches, signals can be transmitted without passing through the image processing units 6a to 6d. In this embodiment, each of the image processing units 6a to 6d comprises a correction operation circuit 5a, 5b, 5c or 5d and a memory 4a, 4b, 4c or 4d that holds input-output characteristic data specific to the respective processing unit areas, which are used for correction operation. Each of the memories 4a to 4d is comprised of a rewritable nonvolatile memory by way of example.

Processes carried out by the image processing units 6a to 6d include gamma correction and shading correction. In this embodiment, the image processing units are assumed to perform correction of gamma characteristics. The correction processing is carried out on each of three primary colors of red (R), green (G) and blue (B) using characteristic data specific thereto. Coefficient parameter data used in interpolation operations and parameter data used to select representative characteristics, which will be described later, as well as input-output characteristic data used in correction operations have values specific to each of R, G and B.

The output video signals 7a to 7d of the respective image processing units 6a to 6d are entered in projectors 8a to 8d, respectively. Each of the projectors 8a to 8d projects a corresponding one of divided images onto a screen (display device) 9. On the screen 9, the divided images are joined together into a single display image. Though not shown, a shading plate for adjusting brightness is placed at that portion between the projectors 8a to 8d and the screen 9, which corresponds to joints of the divided images.

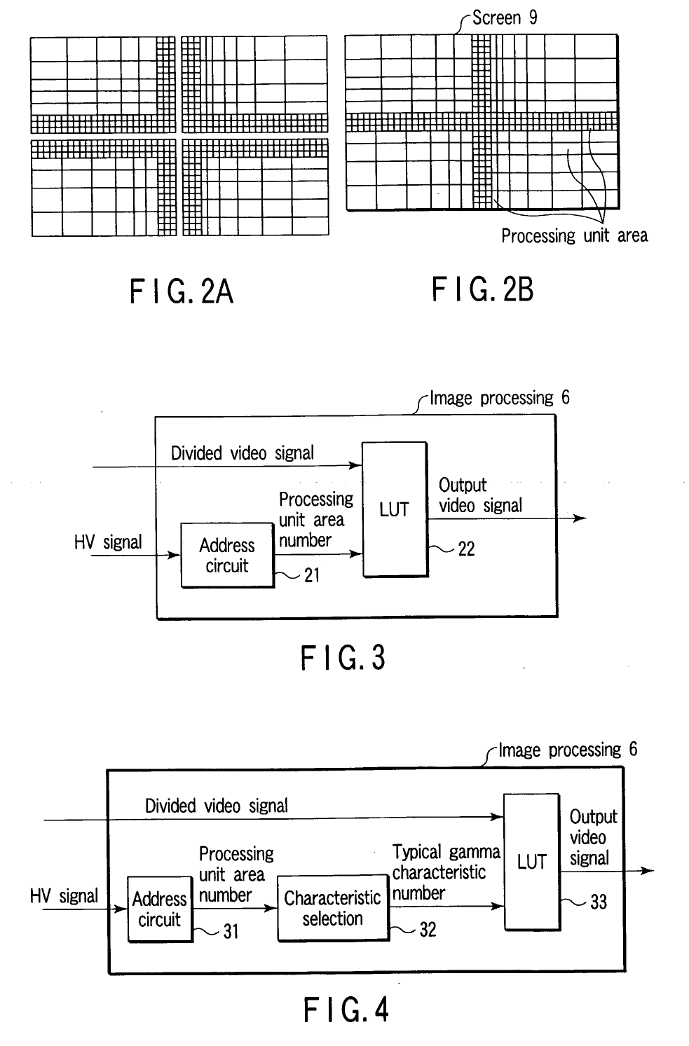

FIGS. 2A and 2B illustrate processing unit areas of the images output from the projectors 8a to 8d. Each of illustrated rectangular area is a processing unit area which serves as a reference unit for correction processing. FIG. 2A illustrates processing unit areas for each of output images of the respective projectors, while FIG. 2B illustrates process unit areas in a state where the images from the projectors are joined together on the screen so that they overlap with each other.

The size of each processing unit area is determined according to a change in gamma characteristic of neighboring pixels. To be specific, an area in which the gamma characteristic changes linearly forms a maximum processing unit area. Therefore, the size of processing unit areas is made smaller in the joint portions where the gamma characteristic is more likely to change abruptly than in the other portions.

The shading plate placed between the projectors and the screen has some influence on other portions than joint portions. Thus, the processing unit area size may be made small even in areas in the neighborhood of the joint portions. That is, the processing unit area size need not be limited to two sizes for joint portions and other portions. Even in other portions than joint portions, the processing unit area size may be changed appropriately according to a change in gamma characteristic. By so doing, efficient area division becomes possible. To be specific, the processing unit area size is set to be small in light-shaded portions corresponding to the joint portions and to increase as the distance from the light-shaded portions increases. This allows the correction processing to be performed in an efficient manner.

FIG. 3 is a block diagram of each of the image processing units 6a to 6d shown in FIG. 1 (indicated at 6 in FIG. 3 and other figures). In this example, the image processing unit 6 is composed of an address circuit 21 and a lookup table (LUT) 22.

Upon receipt of an HV signal representing the current pixel position, the address circuit 21 outputs the number of a processing unit area to which the current pixel belongs. The LUT 22 holds gamma characteristic data corresponding to each processing unit area. Upon receipt of the processing unit area number and a divided video signal, the LUT 22 outputs a gamma corrected video signal data for the corresponding processing unit area as an output video signal.

According to the present embodiment, as described above, the processing unit area size is made to differ between joint sections where images projected onto the screen by the projectors are joined together and other sections and the correction processing is performed for each processing unit area. Therefore, the occurrence of nonuniformity of color and brightness can be suppressed and the amount of data can be prevented from increasing by making the processing unit area size small in joint sections and neighboring sections, which are easy to be affected by the shading plate, and large in other sections apart from the joint sections.

Second Embodiment

A second embodiment of the present invention will be described next, which remains basically unchanged from the first embodiment. Detailed description of corresponding components to those in the first embodiment is omitted (this is the case with other embodiments which will be described later).

FIG. 4 is a block diagram of image processing units 6 of the second embodiment. In this embodiment, the image processing units are each composed of an address circuit 31, a characteristic select memory 32 for making a selection among gamma characteristics, and an LUT 33.

In the present embodiment, a plurality of typical gamma characteristics (256 characteristics in this example) is previously prepared. Selecting from the typical gamma characteristics is performed by calculating gamma characteristic data at each pixel and standardizing (unifying) characteristics having similarity. The correction processing for each processing unit area is performed using a typical gamma characteristic closest to the inherent characteristic of that processing unit area. To this end, the gamma characteristic of each processing unit area is compared with the typical gamma characteristics and correspondence relationship between processing unit area numbers and typical gamma characteristic numbers are stored in the characteristic select memory 32.

The operation of the image processing unit is as follows:

Upon receipt of an HV signal representing the position of the current pixel, the address circuit 31 outputs the number of the processing unit area to which the current pixel belongs. The processing unit area number from the address circuit 31 is applied to the characteristic select memory 32, which in turn outputs the number of the optimum typical gamma characteristic. The LUT 33 holds gamma characteristic data corresponding to the number of each typical gamma characteristic. When receiving the number of a typical gamma characteristic and a divided video signal, the LUT 33 outputs gamma-corrected data for a video signal corresponding to each processing unit area as an output video signal.

Thus, the second embodiment has the same basic workings as the first embodiment. In addition, correction processing for each processing unit area is performed using the optimum gamma characteristic selected from a number of previously stored typical gamma characteristics, thus allowing memory capacity for storing gamma characteristic data to be reduced.

Third Embodiment

A third embodiment of the present invention will be described below.

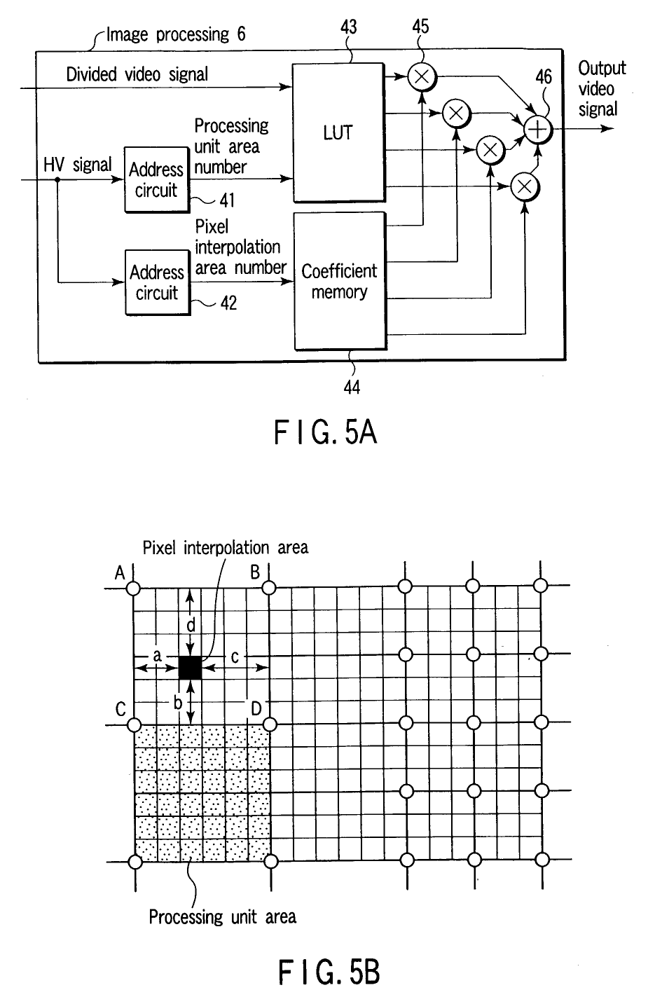

FIG. 5A is a block diagram of image processing units 6 of the third embodiment. In this embodiment, the image processing units 6 are each comprises address circuits 41 and 42, an LUT 43, a coefficient memory 44, and an interpolation operation unit composed of multipliers 45 and an adder 46.

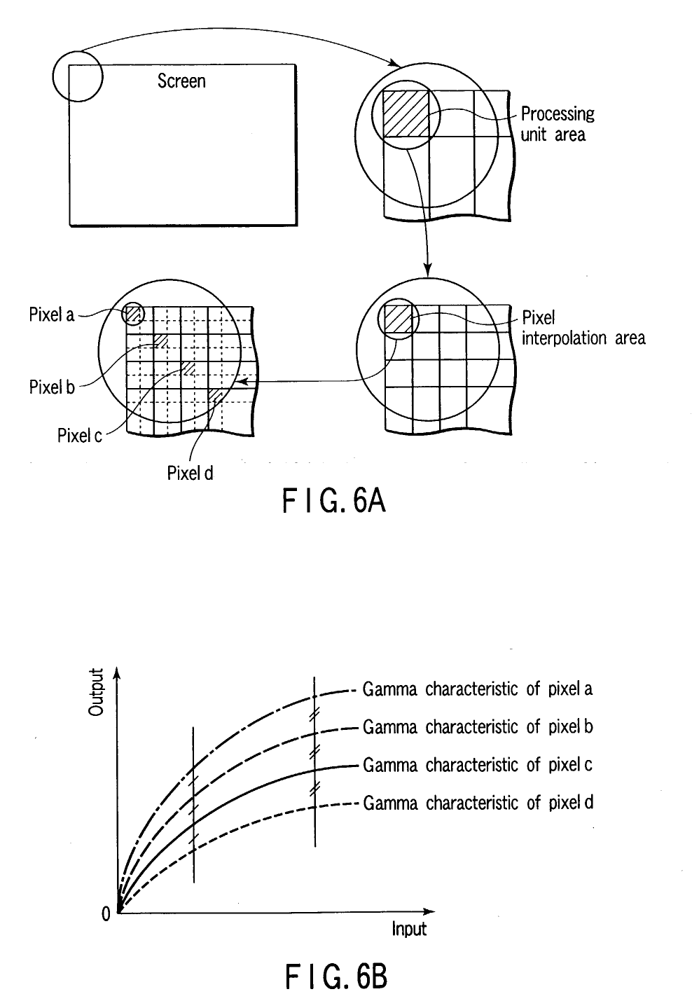

In the present embodiment, a processing unit area comprises a plurality of pixel interpolation areas. The gamma correction processing is performed on a pixel interpolation area basis with the pixel interpolation area as a processing block. FIG. 6A shows a relationship among processing unit area, pixel interpolation area, and pixel. In the present embodiment, as shown in FIG. 5B, the gamma correction for each pixel interpolation area is made on the basis of interpolation operations using gamma corrected values at four vertices (A, B, C, and D) of a processing unit area which is rectangular or square.

The operation of the image processing unit is as follows:

Upon receipt of an HV signal representing the position of the current pixel, the address circuit 41 outputs the number of the processing unit area to which the current pixel belongs and the address circuit 42 outputs the number of the current pixel interpolation area. The LUT 43 holds gamma characteristic data for the four vertices (A, B, C, and D) of each processing unit area. When receiving the number of a processing unit area and a divided video signal, the LUT 43 outputs gamma-corrected data for video signals at the four vertices of that processing unit area. The coefficient memory 44 receives the number of a pixel interpolation area from the address circuit 42 to output the ratio among distances from the sides of the processing unit area to the pixel interpolation area (a, b, c, and d in FIG. 5B). The output data of the LUT 43 and the output data of the coefficient memory 44 are multiplied in the multipliers 45. The multiplication results are added together in the adder 46. Thereby, gamma corrected data for the current pixel interpolation area is obtained by four-point interpolation operations.

Thus, the third embodiment has also the same basic workings as the first embodiment. In addition, the gamma correction for each processing block (corresponding to pixel interpolation area in this embodiment) in each processing unit area is performed by means of interpolation operations, thus allowing memory capacity for storing gamma characteristic data to be reduced.

Although, in the present embodiment, each processing block is formed of a pixel interpolation area made up of two or more pixels; this is not restrictive. Each processing block may consist of a single pixel (this is the case with other embodiments).

Fourth Embodiment

A fourth embodiment of the present invention will be described below.

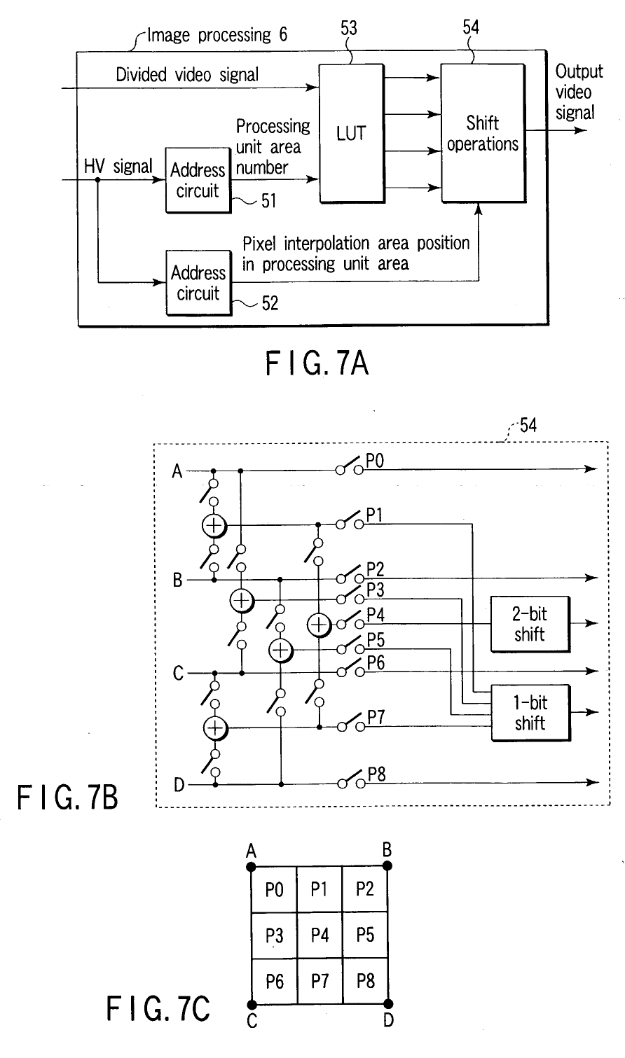

FIG. 7A is a block diagram of image processing units 6 of the fourth embodiment. In this embodiment, the image processing units 6 are each composed of address circuits 51 and 52, an LUT 53, and a shift operation unit 54 as an interpolation operation unit. The unit of correction is the same as in the third embodiment. The processing unit area is rectangular in shape and made up of a total of (2^{m}+1)×(2ⁿ+1) pixel interpolation areas with (2^{m}+1) rows and (2ⁿ+1) columns. Here each of m and n is a positive integer. With this embodiment, it is assumed that m=n=1 and hence the processing unit area is composed of 3×3 (=9) pixel interpolation areas.

FIG. 7B shows the arrangement of the shift operation unit 54. This shift operation unit is constructed from five adders, 19 switches, a 1-bit shift circuit, and a 2-bit shift circuit.

The operation of the image processing unit is as follows:

Upon receipt of an HV signal representing the position of the current pixel, the address circuit 51 outputs the number of the processing unit area to which the current pixel belongs and the address circuit 52 outputs the location number (P0-P8 in FIGS. 7B and 7C) of the current pixel interpolation area. The LUT 53 holds gamma characteristic data for the four vertices (A, B, C, and D) of each processing unit area. When receiving the number of a processing unit area and a divided video signal, the LUT 53 outputs gamma-corrected data for video signals at the four vertices of that processing unit area. The shift operation unit 54 receives each data from the LUT 53 and the location number (P0-P8) of the pixel interpolation area from the address circuit 52 to perform interpolation operations.

The outline of the interpolation operations will be given below.

To perform four-point interpolation on a processing unit area made up of 3×3 processing blocks (pixel interpolation areas), the coefficient of operations can be limited to ½ or ¼. The interpolation operations in the positions P0 to P8 of the respective pixel interpolation areas in a processing unit area are as follows:

P0: A

P1: (A+B)/2

P2: B

P3: (A+C)/2

P4: (A+B+C+D)/4

P5: (B+D)/2

P6: C

P7: (C+D)/2

P8: D

Thus, when the coefficient is ½, a right shift of one bit is simply performed and, when the coefficient is ¼, a right shift of two bits is simply performed. Hence, there is no need of actually performing multiplications.

Thus, the fourth embodiment also functions basically in the same manner as the first and third embodiments. In addition, since the multiplication processing in interpolation operations can be performed by bit shift, the fourth embodiment allows the arrangement of the interpolation operation unit to be simplified in comparison with the third embodiment.

Fifth Embodiment

A fifth embodiment of the present invention will be described below.

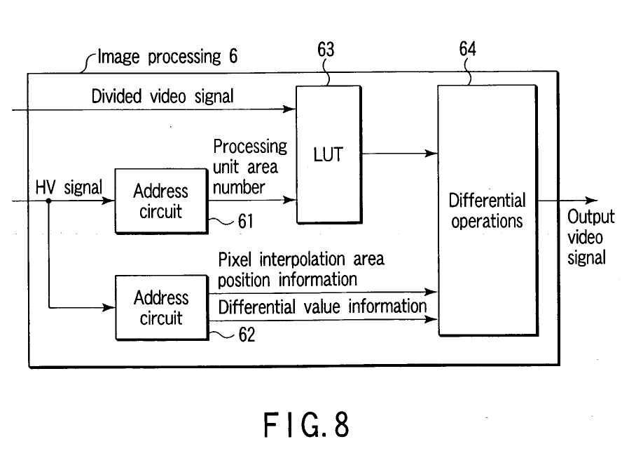

FIG. 8 is a block diagram of image processing units 6 of the fifth embodiment. In this embodiment, the image processing units 6 are each composed of address circuits 61 and 62, an LUT 63, and a differential operation unit 64.

With this embodiment, the input-output characteristics (gamma characteristics) of pixels in each processing unit area linearly vary as shown in FIG. 6B as the pixel position changes from pixel a to pixel d shown in FIG. 6A. That is, in each processing unit area, the input-output characteristic (gamma characteristic) of each of other pixels than the reference pixel (the pixel in reference position (specific area)) is obtained by linearly varying the input-output characteristic of the reference pixel in accordance with the distance from the reference pixel. In other words, an area where such a linear relationship holds is set as a processing unit area. In this embodiment, the reference position is set to be the position of the pixel at the upper left corner (the pixel a in FIG. 6A) in each processing unit area.

The operation of the image processing unit is as follows:

When an HV signal representing the position of the current pixel is applied to the address circuits 61 and 62, the address circuit 61 outputs the number of the processing unit area to which the current pixel belongs. The LUT 63 holds gamma characteristic data for the reference position (the pixel at upper left corner) in each processing unit area. When receiving the number of a processing unit area and a divided video signal, the LUT 63 outputs gamma-corrected data for the video signal corresponding to the reference position. In the address circuit 62, the relationship between the positions of pixel interpolation areas in a processing unit area and the differential values (differential values with respect to a video signal at the reference position (the pixel at upper left corner)) at corresponding positions is set in a table. Upon receipt of an HV signal, the address circuit 62 outputs the position information for the current pixel interpolation area in a processing unit area and differential value information corresponding to that position information.

In response to output data from the LUT 63 and the address circuit 62, the differential operation unit 64 performs differential operations as follows:

Data of reference position (gamma-corrected data) output from the LUT 63 and differential value data output from the address circuit 62 are added together. This add operation is performed a number of times corresponding to the pixel interpolation area position information output from the address circuit 62. Further, the result of addition is multiplied by a constant corresponding to the level of the divided video signal. Thereby, gamma-corrected data is obtained for each pixel interpolation area.

Thus, the fifth embodiment also remains unchanged from the first embodiment in the basic workings. In addition, the gamma correction for each processing block (pixel interpolation area in this example) is performed by differential operations on gamma-corrected data for the reference position, thus allowing memory capacity for storing gamma characteristic data to be reduced.

Sixth Embodiment

A sixth embodiment of the present invention will be described below.

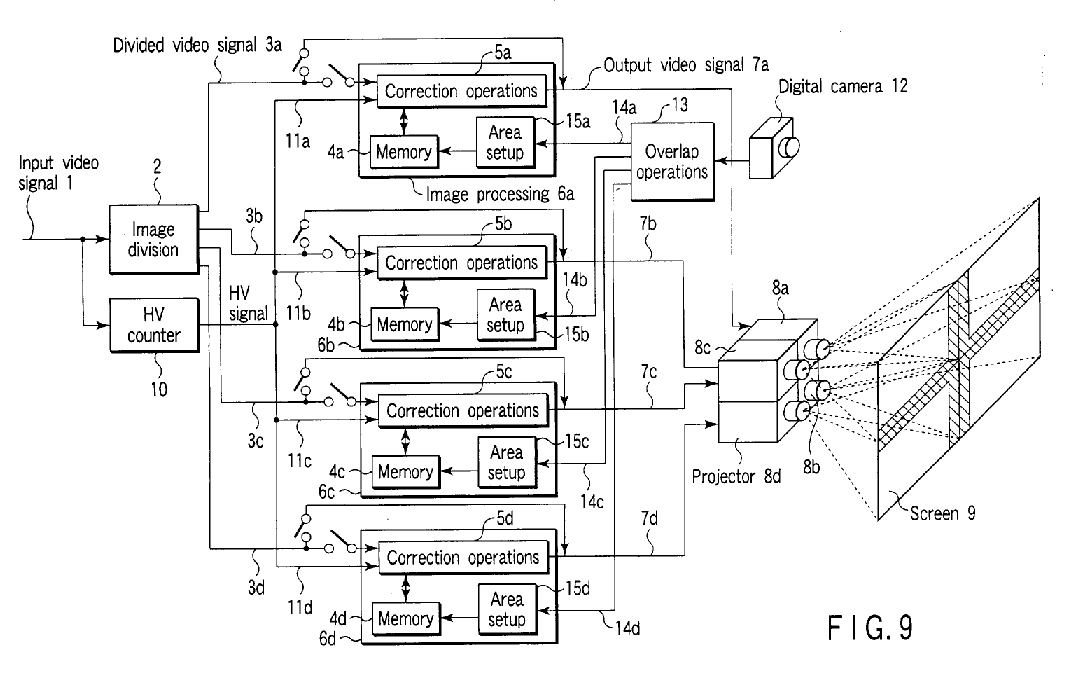

FIG. 9 is a schematic representation of an image display system according to the sixth embodiment. This image display system includes a digital camera (imaging device) 12, an overlap operation circuit 13, and area setup circuits 15a to 15d in addition to the basic configuration of the image display system shown in FIG. 1. The digital camera 12 is adapted to capture the state of the screen 9. The overlap operation circuit 13 determines the size of the overlapped portion of the joint portion of projected images (the degree or the amount of overlapping) on the basis of an image captured by the digital camera 12. The area setup circuits 15a to 15d set the placement and size of each processing unit area on the basis of output information (information concerning the degree of overlapping) from the overlap operation circuit 13 (i.e., how to divide the display area into processing unit areas). The output of the digital camera 12 is input to the overlap operation circuit 13 through the use of a standard serial interface, such as RS232C. Data concerning processing unit areas set up according to the degree of overlapping may be previously stored in a ROM in the area setup circuit or may be stored in an external storage medium.

The operation of the image display system thus configured is as follows:

After the system has been set up, the entire system is shielded from external light. As an input video signal 1 a test image signal is input which allows overlapped portions of images to be grasped readily. At this point, the switches are changed over so that divided signals for the test image are directly applied to the projectors 8a to 8d without passing through the image processing units 6a to 6d. Such a test image is projected onto the screen 9 from the projectors 8a to 8d. The projected image is captured by the digital camera 1 from the back side of the screen 9. The captured image data is entered into the overlap operation circuit 13, which calculates the amounts of overlapping of projected images by the respective projectors 8a to 8d. Overlapping amounts 14a to 14d obtained from calculation results are entered into the area setup circuits 15a to 15d, respectively. In each of the area setup circuits 15a to 15d, data concerning processing unit areas corresponding to input information (data representing a correspondence relationship between pixel positions and processing unit area numbers, etc.) are read from the aforementioned ROM or external storage medium and then written into a corresponding one of memories 4a to 4d. Also, information such as the coefficient used with the interpolation operation system or the typical gamma characteristic select number used with the typical gamma system in the previously described embodiments is read from the ROM or external storage medium and written into the memories 4a to 4d.

Thus, with the sixth embodiment, optimum data is selected from previously stored data concerning processing unit areas according to the degree of overlapping between each divided image on the basis of an image captured by the digital camera. Therefore, automatic optimum setting can be performed even if the degree of overlapping changes due to the movement of the system or the like, allowing the burden imposed on users to be alleviated and the time required by operations processing to be reduced.

Seventh Embodiment

A seventh embodiment of the present invention will be described below.

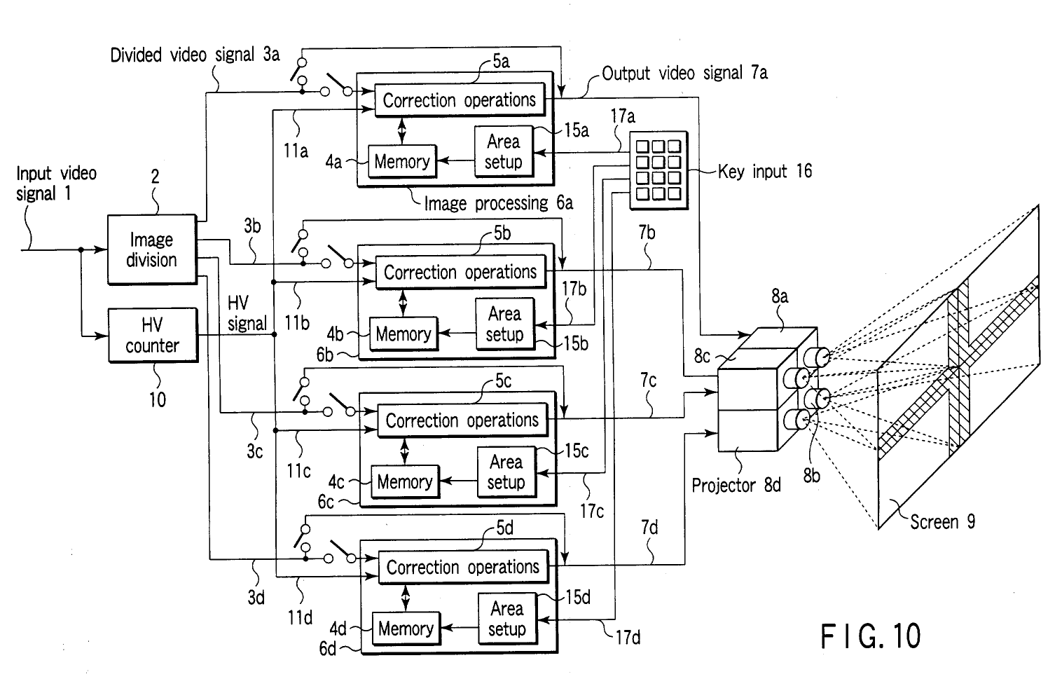

FIG. 10 is a schematic representation of an image display system according to the seventh embodiment. This image display system is provided with a key input device (numerical value input means) in place of the digital camera 12 and the overlap operations circuit 13 in the sixth embodiment shown in FIG. 9. The key input device 16 is used to input numerical value information concerning the degree of overlapping in joints of images. The key input device may be replaced with any other input device, such as a pen input device.

The operation of the image display system will be described below.

After the system has been set up, a test image signal is input as an input video signal 1, which allows overlapped portions of images to be grasped readily. At this point, the switches are changed over so that divided signals for the test image are directly applied to the projectors 8a to 8d without passing through the image processing units 6a to 6d. The user measures the degree of overlapping of joints in the test image projected onto the screen 9. For example, the use of a test image with a grid pattern or graduations would allow the user to grasp easily the degree of overlapping with the naked eye. Subsequently, according to the resulting degree of overlapping in the test image the user enters numerical values 17a to 17d into the area setup circuits 15a to 15d, respectively, through the key input device 16. As in the sixth embodiment, each of the area setup circuits 15a to 15d reads data corresponding to input numerical value information from the ROM or external storage medium and writes them into a corresponding one of the memories 4a to 4d.

Thus, in the seventh embodiment, the image overlapping degree on the screen is measured and optimum data is selected from previously stored data concerning processing unit areas on the basis of numerical value information obtained from the measurements. Therefore, as in the sixth embodiment, the optimum setting can be achieved easily even if the degree of image overlapping changes due to the movement of the system.

According to the present invention, as described so far, image degradations, such as color and brightness nonuniformity, can be suppressed to obtain high-quality images and an increase in the amount of data in correction processing can be suppressed.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image display system which provides a display by joining projected images together, comprising:
a plurality of projecting means for projecting images;
display means for displaying a single image by joining the images from the projecting means together;
dividing means for dividing the images projected by the projecting means into a plurality of processing unit areas; and
correction processing means for performing correction processing for each of the processing unit areas;
wherein the processing unit areas differ in size between joint portions of the images projected by the projecting means and other portions than the joint portions.

2. The image display system according to claim 1, wherein the size of the processing unit areas is smaller in the joint portions than in the other portions.

3. The image display system according to claim 1, wherein the correction processing means performs correction processing on the basis of previously stored input-output characteristic data specific to each of the processing unit areas.

4. The image display system according to claim 2, wherein the correction processing means has select means for selecting an item of input-output characteristic data suitable for each processing unit area from among a plurality of items of previously stored input-output characteristic data and performs correction processing based on the input-output characteristic data selected by the select means.

5. The image display system according to claim 2, wherein the correction processing means performs interpolation operations based on the results of correction processing on at least two specific areas contained in the processing unit area, thereby performing correction processing on a plurality of processing blocks contained in the processing unit area.

6. The image display system according to claim 5, wherein the processing unit area is made up of (2^{m}+1)(2ⁿ+1) processing blocks with (2^{m}+1) rows and (2ⁿ+1) columns where m and n are positive integers, and the interpolation operation is performed using bit shift operations of digital values.

7. The image display system according to claim 1, further comprising storage means for previously storing input-output characteristic data for a specific processing block in a plurality of processing blocks contained in each processing unit area, and wherein the correction processing means seeks input-output characteristic data for other processing blocks than the specific processing block by operations based on a position relationship between the specific processing block and the other processing blocks and the input-output characteristic data previously stored in the storage means and performs correction processing on the basis of the input-output characteristic data previously stored in the storage means and the input-output characteristic data sought by the operations.

8. The image display system according to claim 1, wherein the correction processing means has a function of performing correction processing using input-output characteristic data specific to each of primary colors.

9. The image display system according to claim 1, further comprising:
imaging means for capturing the state on a screen that forms the display means;
determination means for determining the size of overlapped portions in the joint portions on the basis of an image obtained by the imaging means; and
means for setting the size of each processing unit area on the basis of the results of determination by the determination means.

10. The image display system according to claim 1, further comprising:
numerical value input means through which numerical values are externally input; and
means for setting the size of each processing unit area on the basis of numerical values input through the numerical value input means.
